(19) United States
(12) Patent Application Publication
(10) Pub. No.: US 2026/0105171 A1
(43) Pub. Date: Apr. 16, 2026

(54) Adaptable Cybersecurity Playbooks

(71) Applicant: Palo Alto Networks, Inc., Santa Clara, CA (US)

(72) Inventors: Jonathan Allon, Tel Aviv (IL); Uriel David Avraham Mishkin, Tel Aviv (IL); Michal Goldshtein, Santa Clara, CA (US); Netanel Rimer, Givatayim (IL); Yarden Altmann, Givat Shmuel (IL)

(21) Appl. No.: 18/914,180

(22) Filed: Oct. 13, 2024

(51) Int. Cl. G06F 21/62; G06F 21/56

(52) U.S. Cl. CPC G06F 21/6218; G06F 21/566

(57) ABSTRACT

A system includes a communication interface and a processor configured to receive an alert specifying a possible cybersecurity compromise on a computer network and at least one entity associated with the possible cybersecurity compromise. The processor is further configured to execute a playbook, which specifies at least one security action for the alert with an associated condition on at least one property of the entity, in response to receiving the alert, by, via the communication interface, querying a database, which is continually updated with data from the computer network as the computer network is used, for the property of the entity, based on the querying, ascertaining whether the condition is satisfied, and provided the condition is satisfied, performing the security action. Other embodiments are also described.

### FIELD OF EMBODIMENTS OF THE INVENTION

Embodiments of the present invention relate generally to information security, and specifically to cybersecurity playbooks.

### BACKGROUND

A cybersecurity playbook specifies security actions to be taken in response to various types of alerts.

### SUMMARY

There is provided, in accordance with some embodiments of the present invention, a system including a communication interface and a processor. The processor is configured to receive an alert specifying a possible cybersecurity compromise on a computer network and at least one entity associated with the possible cybersecurity compromise, and to execute a playbook, which specifies at least one security action for the alert with an associated condition on at least one property of the entity, in response to receiving the alert, by, via the communication interface, querying a database, which is continually updated with data from the computer network as the computer network is used, for the property of the entity, based on the querying, ascertaining whether the condition is satisfied, and provided the condition is satisfied, performing the security action.

There is further provided, in accordance with some embodiments of the present invention, a method including receiving an alert specifying a possible cybersecurity compromise on a computer network and at least one entity associated with the possible cybersecurity compromise, and in response to receiving the alert, executing a playbook, which specifies at least one security action for the alert with an associated condition on at least one property of the entity, by querying a database, which is continually updated with data from the computer network as the computer network is used, for the property of the entity, based on the querying, ascertaining whether the condition is satisfied, and provided the condition is satisfied, performing the security action.

In some embodiments, the database is continually updated with other data from one or more other computer networks as the other computer networks are used.

In some embodiments, the method further includes updating the condition in response to feedback from a user.

In some embodiments, the entity includes a user of the computer network.

In some embodiments, the computer network belongs to an organization, and the property includes a role of the user in the organization.

In some embodiments, the entity includes a file stored on the computer network.

In some embodiments, the property includes a measure of pervasiveness of the file on the computer network.

In some embodiments, the entity includes an element specified in a web request originating from the computer network.

In some embodiments, the property includes a measure of pervasiveness of the element in web requests originating from the computer network.

In some embodiments, the entity includes a device belonging to the computer network.

In some embodiments, the property includes a role of the device in the computer network.

There is further provided, in accordance with some embodiments of the present invention, a computer software product including a tangible non-transitory computer-readable medium in which program instructions are stored. The instructions, when read by a processor, cause the processor to receive an alert specifying a possible cybersecurity compromise on a computer network and at least one entity associated with the possible cybersecurity compromise, and to execute a playbook, which specifies at least one security action for the alert with an associated condition on at least one property of the entity, in response to receiving the alert, by querying a database, which is continually updated with data from the computer network as the computer network is used, for the property of the entity, based on the querying, ascertaining whether the condition is satisfied, and provided the condition is satisfied, performing the security action.

The present invention will be more fully understood from the following detailed description of embodiments thereof, taken together with the drawings, in which:

### BRIEF DESCRIPTION OF THE DRAWINGS

FIG. 1 is a schematic illustration of a cybersecurity system, in accordance with some embodiments of the present invention; and

FIG. 2 is a flow diagram for a method for performing a security action, in accordance with some embodiments of the present invention.

### DETAILED DESCRIPTION

### Overview

A problem with traditional cybersecurity playbooks is that these playbooks have limited adaptability. For example, for a given type of alert, a traditional playbook may define a certain security action regardless of the broader context in which the alert was generated.

For example, a traditional cybersecurity playbook might specify that any file having certain properties is to be considered potentially malicious, and therefore is to be quarantined. However, some computer networks might store many non-malicious files having these properties. If all these files were to be quarantined, crucial network functionality might be affected. Alternatively, even if the network stores only one such file, crucial network functionality might be affected if the file is required by a domain controller or another device having an important role in the network. Alternatively, even if it is the case, at the present time, that most files having these properties are malicious, this may not be true at a future time.

To address this shortcoming, embodiments of the present invention provide an adaptable cybersecurity playbook in which security actions are conditional on the broader context in which the alerts are generated. In particular, a database is continually updated with data from the network on which the playbook is deployed and from other networks (e.g., the Internet). The data includes information on the devices and users in the network, such as the role of each device and user, and on files and applications used in the network. Upon receiving an alert, a cybersecurity server executes the playbook by querying the database for relevant data and performing the specified security action only if certain conditions on the data, which are specified in the playbook, are satisfied.

For example, in some embodiments, the playbook specifies that a suspicious file is to be quarantined only if the file is not in use by a device having an important role (e.g., a device hosting a domain controller) or a user having an important role (e.g., an executive role), and only if the file is relatively uncommon.

In the context of the present application, including the claims, the term “cybersecurity” includes the security of any data and/or resource on a computer or computer network, and thus encompasses both information security and computer security. A threat or compromise to the cybersecurity of a computer network can come from any manual or automatic process initiated from within or from outside the network.

### System Description

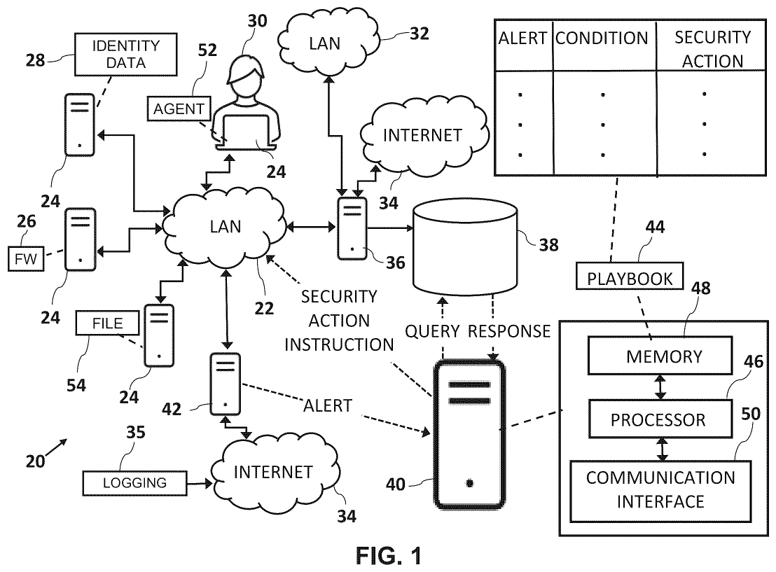

Reference is initially made to FIG. 1, which is a schematic illustration of a cybersecurity system 20, in accordance with some embodiments of the present invention.

System 20 comprises a server 40 configured to receive alerts specifying possible cybersecurity compromises on a computer network 22, such as a local area network (LAN). Typically, multiple computing devices 24, such as desktop computers, laptops, and/or smartphones, belong to computer network 22. Further typically, at least some of devices 24 are used by users 30. In some embodiments, computer network 22 belongs to an organization such as a business.

Examples of cybersecurity compromises include the presence of a malicious file 54 (e.g., a document, a media file, or a file containing instructions for running an application) on the computer network, unauthorized access to a resource (e.g., a file, a device 24, or a database) on the computer network by a user 30 or by an automated process, and a cybersecurity attack (e.g., an application programming interface attack, such as a broken object level authorization or distributed denial-of-service attack) on the computer network. Other examples include activity, such as a creation (e.g., in a cloud environment) of a compute instance or a change to configurations, that compromises sensitive data, network reconnaissance activity, and a malicious web request (e.g., Hypertext Transfer Protocol request), such as a request to a malicious host.

Server 40 comprises a processor 46, a memory 48, which typically comprises a volatile memory (e.g., a random access memory) and a nonvolatile memory (e.g., a flash memory), and a communication interface 50, such as a network interface controller. Processor 46 is configured to exchange communication via communication interface 50. For example, in some embodiments, processor 46 receives the alerts via communication interface 50. As further described below, in response to some of the alerts, the processor performs security actions specified in a playbook 44 stored in memory 48. Examples of security actions include the quarantining of a file, the automatic logout of a user 30, the enforcement of multi-factor authentication for a user 30, the killing of a process tree, and the adding of a firewall rule.

Typically, the alerts are generated by another server 42. Typically, server 42 generates the alerts based on data collected by one or more monitoring entities installed on devices 24, such as a firewall 26 and/or other software agents 52 configured to monitor application programming interface transactions and/or any other activity. Alternatively or additionally, server 42 generates the alerts based on data collected by an external monitoring entity, such as a logging service 35 configured to monitor cloud infrastructure. Server 42 is configured to communicate the alerts to server 40.

Alternatively, server 40 executes two separate modules—one module for generating the alerts, and another for receiving and acting on the alerts as described herein.

Typically, system 20 further comprises another server 36 configured to continually update a database 38 with data from computer network 22 as the computer network is used. Examples of such data include identity data 28 for users 30, which may include, for example, the username of each user 30 and the role of the user in the organization to which computer network 22 belongs. Examples further include a measure of pervasiveness of a file 54 on the computer network, such as the number of times the file was accessed on the computer network or the number of instances of the path or hash of the file on the computer network. (The hash of a file is obtained by passing the contents of the file through a hashing function, such that any two files having different content also have different hashes.) Examples further include a measure of pervasiveness of an element (e.g., a domain name, an Internet Protocol address, or a user agent) specified in web requests originating from the computer network, e.g., the number of such requests specifying the element or the number of days in which the element was specified. Examples further include a list of devices belonging to the computer network and the role of each device.

Typically, server 36 is further configured to continually update database 38 with other data from one or more other computer networks, such as another local area network 32 and/or the Internet 34, as the other computer networks are used. Examples of such data include a measure of pervasiveness of a file 54, such as the number of instances of the path or hash of the file on network 32 or the number of times the file was downloaded from Internet 34, and a measure of pervasiveness of an element specified in web requests, such as the number of web requests that specify the element.

Each alert specifies, in addition to the possible cybersecurity compromise, at least one entity associated with the possible cybersecurity compromise. For example, each alert may specify the identity of a device 24, a user 30, a file 54, a web-request element, a process, a cloud bucket, a hard disk, a virtual machine, and/or an application. As a specific example, an alert for a possibly malicious file 54 may identify the file and the device(s) on which the file was found. As another specific example, an alert for possible unauthorized access may identify the user who initiated the access and the device on which the access was initiated. As another specific example, an alert for a possibly malicious web request may identify the domain name, source Internet Protocol address, destination Internet Protocol address, and/or user agent specified in the web request, the device from which the request originated, and/or the user who initiated the request.

Advantageously, playbook 44 does not merely specify a security action for each type of alert. Rather, for at least one type of alert, playbook 44 associates, with the specified security action, a condition on at least one property of at least one entity specified by the alert. In response to receiving each alert, processor 46 executes the playbook by querying database 38, via communication interface 50, for the property of the entity specified by the alert. Based on the querying (i.e., based on the data contained in the response to the query), the processor ascertains whether the condition is satisfied. Provided the condition is satisfied, the processor performs the security action specified by the playbook for the alert, typically by communicating an appropriate instruction over computer network 22.

In some embodiments, for at least one type of alert, playbook 44 specifies multiple security actions with respective associated conditions. In response to receiving each alert, processor 46, by executing the playbook, checks each of the conditions and performs any of the security actions for which the associated condition is satisfied.

Thus, advantageously, the processor's response to the alert—i.e., whether the processor performs any security action, and if so, which action(s)—is dependent on the broader context of the alert.

For example, for an alert specifying a user, the security action (e.g., an automatic logging out of the user) may be conditional on the role of the user in the organization. For example, the security action may be performed if the user is a lower-ranking employee, but not if the user has an executive role.

Alternatively or additionally, if the alert specifies a device 24, the security action (e.g., the killing of a process tree on the device) may be conditional on the role of the device in the computer network. For example, the security action may be performed if the device is a regular device, but not if the device hosts a critical service such as a firewall or domain controller.

Alternatively or additionally, if the alert specifies a file 54, the security action (e.g., a quarantining of the file) may be conditional on a measure of pervasiveness of the file. For example, the security action may be performed if the file has relatively low pervasiveness, but not if the file has relatively high pervasiveness.

As a specific example, the processor may receive an alert regarding the execution of a suspicious file, the alert specifying the file and the device on which the file was executed. For this type of alert, the playbook may specify a security action of quarantining the file, with a first associated condition on the file and a second associated condition on the device. For example, the conditions may require that a measure of pervasiveness of the file (e.g., the total number of instances of the hash of the file over all the networks monitored by server 36) be less than a predefined threshold and that the device not be a domain controller of computer network 22. The processor may therefore query database 38 for the measure of pervasiveness and for the role of the device in the computer network. Provided the conditions are satisfied, the processor may quarantine the file.

In some embodiments, for at least some types of alerts, the processor is configured to relay the alert to a security analyst in the event that the condition(s) are not satisfied.

In some embodiments, processor 46 is configured to update a condition in playbook 44 in response to feedback from a user 30. For example, if the user reports that a non-malicious file was erroneously quarantined by the processor, the processor may decrease the threshold on the measure of pervasiveness such that, in the future, even less pervasive files are not quarantined.

In general, processor 46 may be embodied as a single processor, or as a cooperatively networked or clustered set of processors. The functionality of processor 46 may be implemented solely in hardware, e.g., using one or more fixed-function or general-purpose integrated circuits, Application-Specific Integrated Circuits (ASICs), and/or Field-Programmable Gate Arrays (FPGAs). Alternatively, this functionality may be implemented at least partly in software. For example, processor 46 may be embodied as a programmed processor comprising, for example, a central processing unit (CPU) and/or a Graphics Processing Unit (GPU). Program code, including software programs, and/or data may be loaded for execution and processing by the CPU and/or GPU. The program code and/or data may be downloaded to the processor in electronic form, over a network, for example. Alternatively or additionally, the program code and/or data may be provided and/or stored on non-transitory tangible media, such as magnetic, optical, or electronic memory. Such program code and/or data, when provided to the processor, produce a machine or special-purpose computer, configured to perform the tasks described herein.

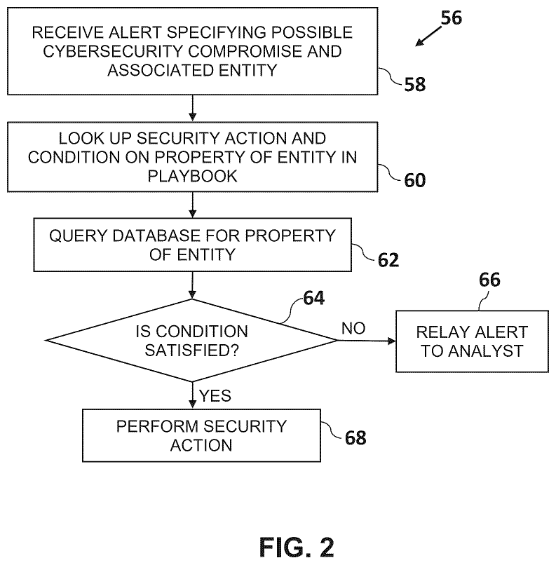

Reference is now additionally made to FIG. 2, which is a flow diagram for a method 56 for performing a security action, which is executed by processor 46 in accordance with some embodiments of the present invention.

At an alert-receiving step 58, the processor receives an alert specifying a possible cybersecurity compromise on computer network 22 and at least one entity associated with the possible cybersecurity compromise. In response to receiving the alert, the processor, at a lookup step 60, looks up, in playbook 44, the security action specified for this type of alert, along with the associated condition on a property of the entity. The processor then queries database 38 for the property of the entity at a querying step 62, i.e., the processor submits a query and receives a response to the query. Subsequently, at a checking step 64, the processor checks, based on the data contained in the response, whether the condition is satisfied. If yes, the processor performs the security action at an action-performing step 68. Otherwise, the processor relays the alert to a security analyst at a relaying step 66.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A system, comprising:
a communication interface; and
a processor, configured to:
receive an alert specifying a possible cybersecurity compromise on a computer network and at least one entity associated with the possible cybersecurity compromise, and
in response to receiving the alert, execute a playbook, which specifies at least one security action for the alert with an associated condition on at least one property of the entity, by:
via the communication interface, querying a database, which is continually updated with data from the computer network as the computer network is used, for the property of the entity,
based on the querying, ascertaining whether the condition is satisfied, and
provided the condition is satisfied, performing the security action.

2. A method, comprising:
receiving an alert specifying a possible cybersecurity compromise on a computer network and at least one entity associated with the possible cybersecurity compromise; and
in response to receiving the alert, executing a playbook, which specifies at least one security action for the alert with an associated condition on at least one property of the entity, by:
querying a database, which is continually updated with data from the computer network as the computer network is used, for the property of the entity,
based on the querying, ascertaining whether the condition is satisfied, and
provided the condition is satisfied, performing the security action.

3. The method according to claim 2, wherein the database is continually updated with other data from one or more other computer networks as the other computer networks are used.

4. The method according to claim 2, further comprising updating the condition in response to feedback from a user.

5. The method according to claim 2, wherein the entity includes a user of the computer network.

6. The method according to claim 5, wherein the computer network belongs to an organization, and wherein the property includes a role of the user in the organization.

7. The method according to claim 2, wherein the entity includes a file stored on the computer network.

8. The method according to claim 7, wherein the property includes a measure of pervasiveness of the file on the computer network.

9. The method according to claim 2, wherein the entity includes an element specified in a web request originating from the computer network.

10. The method according to claim 9, wherein the property includes a measure of pervasiveness of the element in web requests originating from the computer network.

11. The method according to claim 2, wherein the entity includes a device belonging to the computer network.

12. The method according to claim 11, wherein the property includes a role of the device in the computer network.

13. A computer software product comprising a tangible non-transitory computer-readable medium in which program instructions are stored, which instructions, when read by a processor, cause the processor to:
receive an alert specifying a possible cybersecurity compromise on a computer network and at least one entity associated with the possible cybersecurity compromise, and
in response to receiving the alert, execute a playbook, which specifies at least one security action for the alert with an associated condition on at least one property of the entity, by:
querying a database, which is continually updated with data from the computer network as the computer network is used, for the property of the entity,
based on the querying, ascertaining whether the condition is satisfied, and
provided the condition is satisfied, performing the security action.

14. The computer software product according to claim 13, wherein the database is continually updated with other data from one or more other computer networks as the other computer networks are used.

15. The computer software product according to claim 13, wherein the instructions further cause the processor to update the condition in response to feedback from a user.

16. The computer software product according to claim 13, wherein the entity includes a user of the computer network.

17. The computer software product according to claim 16, wherein the computer network belongs to an organization, and wherein the property includes a role of the user in the organization.

18. The computer software product according to claim 13, wherein the entity includes a file stored on the computer network.

19. The computer software product according to claim 18, wherein the property includes a measure of pervasiveness of the file on the computer network.

20. The computer software product according to claim 13, wherein the entity includes an element specified in a web request originating from the computer network.

21. The computer software product according to claim 20, wherein the property includes a measure of pervasiveness of the element in web requests originating from the computer network.

22. The computer software product according to claim 13, wherein the entity includes a device belonging to the computer network.

23. The computer software product according to claim 22, wherein the property includes a role of the device in the computer network.
